(19) United States
(12) Patent Application Publication
(10) Pub. No.: US 2008/0313646 A1
(43) Pub. Date: Dec. 18, 2008

(54) STORAGE-DEVICE DISCOVERY PROTOCOL

(76) Inventors: Jesus R. Acevedo, Tucson, AZ (US); Benjamin J. Donie, Tucson, AZ (US); Michael L. Hernandez, Tucson, AZ (US); Andreas B. Koster, Vail, AZ (US); Hin C. Lam, Tucson, AZ (US); Richard K. Martinez, Tucson, AZ (US)

Correspondence Address: Kunzler & McKenzie, 8 EAST BROADWAY, SUITE 600, SALT LAKE CITY, UT, 84111, US

(21) Appl. No.: 11/764,112

(22) Filed: Jun. 15, 2007

(51) Int. Cl. G06F 9/46

(52) U.S. Cl. 719/312

(57) ABSTRACT

A system and method may include a first storage device supporting a first set of functions and a second storage device supporting a second set of functions different from the first set of functions. The first and second storage devices may be configured to provide a common interface to enable discovery of the first and second sets by invoking a procedure call common to the first and second storage devices. An application, which may initially be unaware of the first and second sets, may be configured to invoke the procedure call and thereby discover the first and second sets, which may be provided as XML documents. The application may be further configured to communicate with the first storage device using the first set of functions, and communicate with the second storage device using the second set of functions using the information discovered by invoking the procedure call.

### BACKGROUND OF THE INVENTION

1. Field of the Invention

This invention relates to data storage devices and more particularly to systems and methods for communicating with heterogeneous data storage devices.

2. Description of Related Art

The Common Information Model (CIM) is a standard that defines how managed elements (i.e., computing and business entities) are represented and managed in internet, enterprise, and service provider environments. One goal of CIM is to provide a unified model for representing data from heterogeneous data sources so that it can be retrieved and manipulated by any CIM-compliant application.

In general, referring to FIG. 1, a prior art system 100 utilizing CIM may include an application 102 which may be configured to function as a CIM client 102. The CIM client 102 may interact with a CIM Object Manager (CIMOM) server 104 by transmitting CIM Operation Message Requests to the CIMOM server 104 and receiving and processing CIM Operation Message Responses from the CIMOM server 104. The CIMOM server 104, by contrast, may communicate with a storage device 108 using a device's native network interface 106.

A system 100 utilizing CIM is not without shortcomings, however. A CIMOM server 104 may be difficult to configure and may create performance problems by inserting an additional layer 104 of software between the application 102 and storage device 108. Each storage device 108 may also require an additional or different CIMOM server 104 to operate, thereby increasing costs for the customer. Server versioning, which ensures that an appropriate server version is used with the storage device 108 and application 102, may also be problematic. Finally, a CIMOM server 104 may not support new features or functions supported by the storage device 108, making these features unusable without bypassing the CIMOM server 104. Because adding support for new features and functions to the CIMOM server 104 may require a lengthy approval process by a standards-making body, the features supported by the CIMOM server 104 may lag behind those supported by the storage device 108 and application 102.

In view of the foregoing, what is needed is a system and method to overcome some or all of the shortcomings described above when using CIM to communicate with storage devices 108. Ideally, such an apparatus and method would enable communication with various heterogeneous storage devices, regardless of the features and functions supported by each device.

### SUMMARY OF THE INVENTION

The present invention has been developed in response to the present state of the art, and in particular, in response to the problems and needs in the art that have not yet been fully solved by currently available systems and methods. Accordingly, the present invention has been developed to provide improved systems and methods to communicate with heterogeneous data storage devices.

In a first aspect of the invention, a system in accordance with the invention may include a first storage device supporting a first set of functions and a second storage device supporting a second set of functions distinct from the first set of functions. The first and second storage devices may be configured to provide a common interface to enable discovery of the first and second sets by invoking a procedure call understood by the first and second storage devices. An application, which initially may be unaware of the first and second sets, may be configured to invoke the procedure call and thereby discover the first and second sets. This information may be provided in the form of XML documents. The application may be further configured to communicate with the first storage device using the first set of functions, and communicate with the second storage device using the second set of functions using the information discovered by invoking the procedure call.

In a second aspect of the invention, a method in accordance with the invention may include providing a first storage device supporting a first set of functions and a second storage device supporting a second set of functions different from the first set of functions. The method may further include providing, by the first and second storage devices, a common interface to enable discovery of the first and second sets by invoking a procedure call common to the first and second storage devices. Next, the method may include invoking the procedure call to discover the first and second sets and communicating with the first storage device using the first set of functions and communicating with the second storage device using the second set of functions.

The present invention provides novel systems and methods for communicating with heterogeneous data storage devices. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 is a high-level block diagram illustrating one example of a prior art system for communicating with a storage device using a CIMOM server;

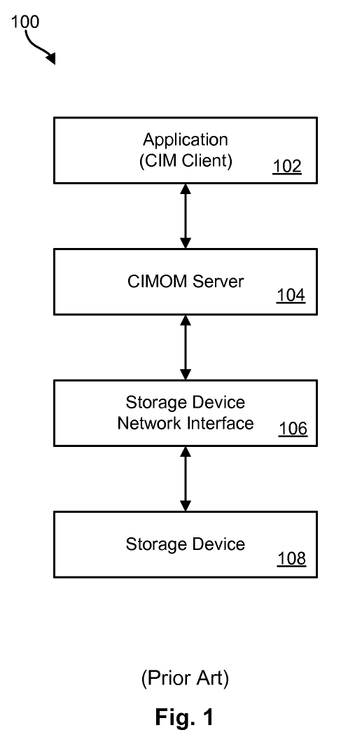

FIG. 2 is a high-level block diagram illustrating one embodiment of a system for communicating with various heterogeneous storage devices; and

FIG. 3 is an example of one embodiment of an XML document identifying various characteristics and functions supported by a storage device.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of systems and methods in accordance with the present invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

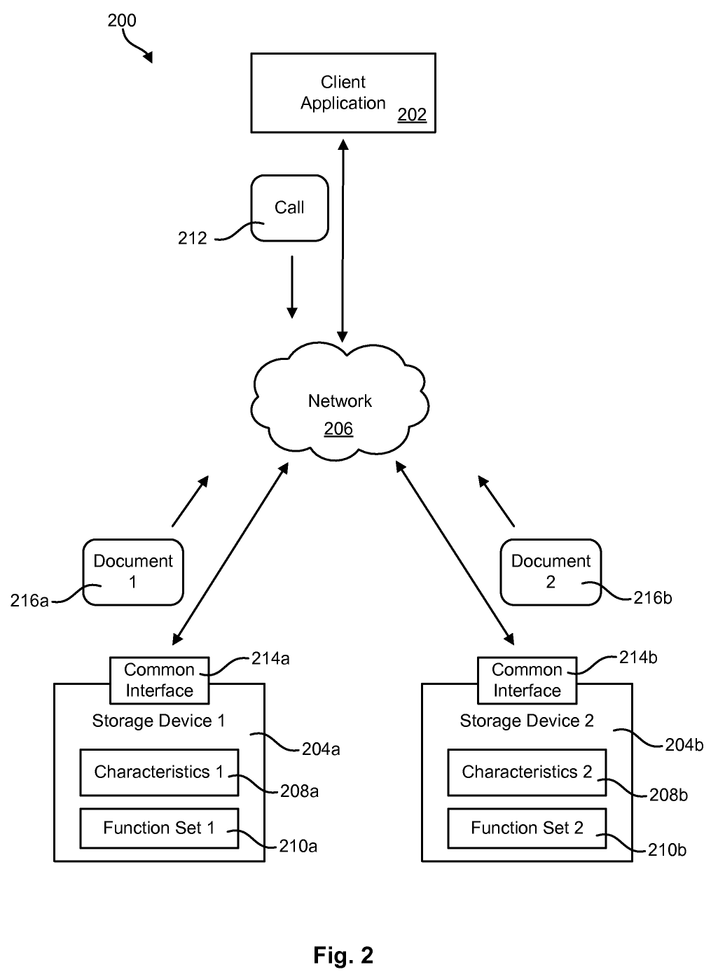

Referring to FIG. 2, in selected embodiments, a system 200 in accordance with the invention may enable communication with various heterogeneous storage devices 204a, 204b. Such a system 200 may include a client application 202 and one or more storage devices 204a, 204b communicating through a network 206. The storage devices 204a, 204b may include, for example, tape servers, storage-area-network (SAN) arrays, network-attached-storage (NAS) arrays, direct access storage devices (DASD), or storage servers of various types. Similarly, the client application 202 may include any type of application 202 seeking to access, retrieve, or store data on the storage devices 204a, 204b.

The client application 202 may initially be unaware of the protocol required to communicate with the one or more of the storage devices 204a, 204b. That is, the client application 202 may be unaware or lack information regarding the characteristics of the z storage devices 204a, 204b, such as a device type, make, model, version, or unique identifier associated with the devices 204a, 204b. The client application 202 may also be unaware of the functions supported by a storage device as well as information on how to use the functions. Thus, initially, the client application 202 may be unable to exploit many or all of the capabilities of the storage devices 204a, 204b because it lacks the information needed to do so.

In selected embodiments, the storage devices 204a, 204b are heterogeneous devices 204a, 204b. That is, the devices 204a, 204b may each include characteristics 208a, 208b, and support functions 210a, 210b distinct from one another. For example, a first storage device 204a may be tape server having a first set of characteristics 208a and supporting a first set of functions 210a and the second storage device 204b may be a DASD device having a second set of characteristics 208b and supporting a second set of functions 210b. Thus, a client application 202 may need to use different functions, protocols, or the like if and when it communicates with each of the storage devices 204a, 204b.

Because the client application 202 is initially unaware of the identity, characteristics 208a, 208b, and functions 210a, 210b of the storage devices 204a, 204b, a system and method is needed to enable the client application 202 to discover this information and use this information to communicate with the devices 204a, 204b. Accordingly, in selected embodiments, a client application 202 may be configured to invoke a procedure call 212 or issue a request 212 which may be understood and responded to by each of the storage devices 204a, 204b. Accordingly, the storage devices 204a, 204b may be configured to have a common interface 214a, 214b to receive and respond to this call 212.

In selected embodiments, the storage devices 204a, 204b may respond to the call 212 by issuing a document 216a, 216b to the client application 202 defining characteristics 208a, 208b and functions 210a, 210b corresponding to the storage devices 204a, 204b. The client application 202 may receive and parse these documents 216a, 216b to extract information contained therein. Using this information, the application 202 may communicate with each of the devices 204a, 204b by calling the functions native to each device 204a, 204b.

In other embodiments, rather than responding to a call 212, the storage devices 204a, 204b may periodically broadcast a document 216a, 216b or message 216a, 216b across the network 206. These broadcasts may provide information regarding the existence of the storage devices 204a, 204b and the means for communicating with these devices 204a, 204b. These broadcasts may be detected and parsed by one or more client applications 202 to enable communication between the applications 202 and the storage devices 204a, 204b.

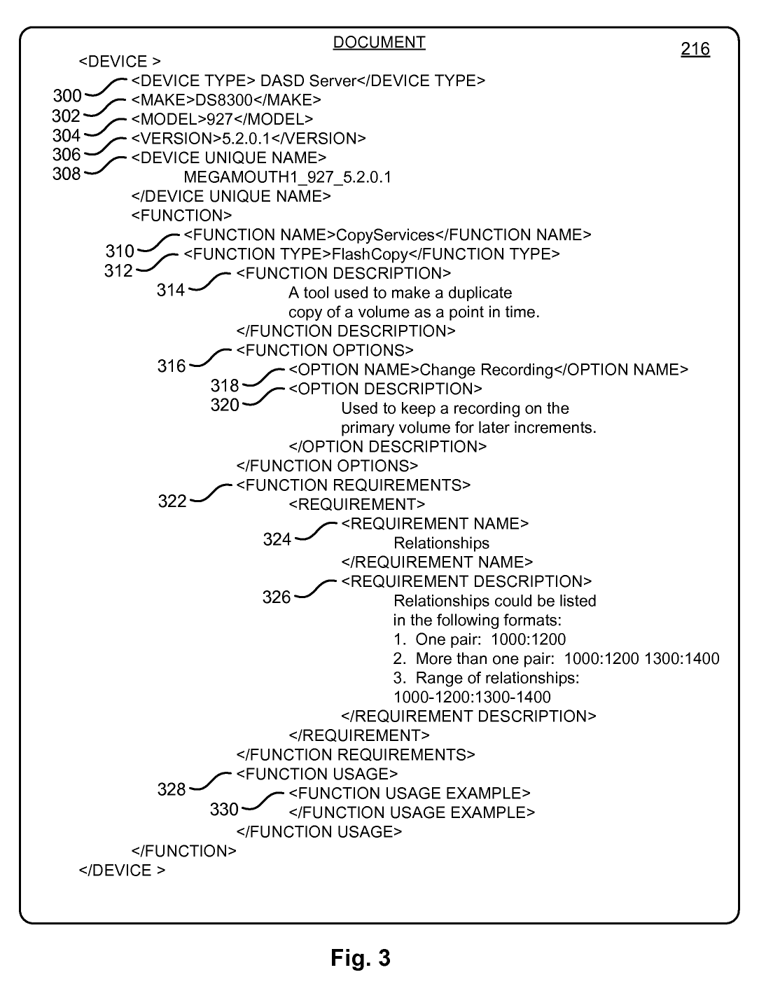

Referring to FIG. 3, in certain embodiments, the documents 216a, 216b illustrated in FIG. 2 are formatted as XML documents. Client applications 202 may include XML parsers to extract the information contained within the documents 216a, 216b.

One embodiment of an XML document 216 is illustrated showing various elements and information that may be contained within a document 216 in accordance with the invention. For example, one embodiment of an XML document 216 may identify characteristics 208a, 208b such as device type 300 (e.g., DASD server, tape server, etc.), device make 302 (e.g., DS8300), and device model 304 (e.g., 927) associated with a storage device 204a, 204b. The document may also reference characteristics 208a, 208b such as version number 306 and unique names 308 (e.g., MAC address, WWNN, WWPN, etc.) associated with a particular storage device 204a, 204b.

The document 216 may also describe which functions 210a, 210b are supported by a storage device 204a, 204b. For example, the document 216 may provide names 310 of functions or classes (e.g., CopyServices) supported by the storage device 204a, 204b as well as function types (i. e., sub-functions) or methods within each function or class. In selected embodiments, each function 312 may include a function description 314 as well as one or more function options 316. These options 316 may also include an associated name 318 (e.g., Change Recording) and description 320.

Each function 312 may also be defined by function requirements 322 which may describe, for example, the function format, parameters, or other information needed to invoke and use a function 312. In selected embodiments, each requirement 322 may include a requirement name 324 and requirement description 326. In other embodiments, function usage information 328 may be provided to give additional information regarding how to use a function and what the function does. For example, function usage examples 330 may provide specific examples, best practices, tips, suggestions, warnings, error message information, or other information that may be useful when using or trying to understand a function 312. The document 216 is not limited to providing the information described above, but may provide other information, as needed, to describe other features and characteristics of a storage device 204a, 204b.

The storage-device discovery protocol described above is highly useful because it provides a unified method for discovering functions and characteristics associated with various heterogeneous data storage devices 204a, 204b. The protocol reduces problems with versioning because a client application 202 can be configured to use only functions returned in the document 216 of a particular storage device 204. The protocol also enables an application 202 to communicate with various storage devices 204a, 204b that it had little knowledge of beforehand. Additionally, the protocol may allow an application 202 to exploit new features and functions of a storage device 204a, 204b by removing the CIMOM server 104 layer. This may also improve performance and reduce costs for a customer.

Although the discovery protocol has been discussed primarily in association with storage devices 204a, 204b, it should be recognized that the protocol described herein may be used with a wide variety of different communication devices, including but not limited to storage devices, switches, routers, bridges, servers, or other communication devices. That is, the protocol may be used to discover the identity and functions supported by and associated with a wide variety of different devices. Such a protocol may be especially useful to provide connectivity between mobile devices and various foreign devices that the mobile device is either unaware of or lacks the knowledge to communicate with.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a first storage device supporting a first set of functions;
a second storage device supporting a second set of functions different from the first set of functions;
the first and second storage devices providing a common interface to enable discovery of the first and second sets by invoking a procedure call common to the first and second storage devices;
an application, initially unaware of the first and second sets, configured to invoke the procedure call and thereby discover the first and second sets; and
the application further configured to communicate with the first storage device using the first set of functions, and communicate with the second storage device using the second set of functions.

2. The system of claim 1, wherein the application discovers the first and second sets by receiving XML documents from the first and second storage devices and describing the first and second sets.

3. The system of claim 2, wherein the XML documents further describe at least one of a type, make, model, version, and unique name associated with the first and second storage devices.

4. A method comprising:
providing a first storage device supporting a first set of functions;
providing a second storage device supporting a second set of functions different from the first set of functions;
providing, by the first and second storage devices, a common interface to enable discovery of the first and second sets by invoking a procedure call common to the first and second storage devices;
invoking the procedure call to discover the first and second sets; and
communicating with the first storage device using the first set of functions and communicating with the second storage device using the second set of functions.

5. The method of claim 4, wherein discovering the first and second sets comprises receiving XML documents describing the first and second sets.

6. The method of claim 5, wherein discovering further comprises discovering at least one of a type, make, model, version, and unique name associated with the first and second storage devices.

7. A system comprising:
a first communication device supporting a first set of functions;
a second communication device supporting a second set of functions different from the first set of functions;
the first and second communication devices providing a common interface to enable discovery of the first and second sets by invoking a procedure call common to the first and second communication devices;
an application configured to invoke the procedure call and thereby discover the first and second sets; and
the application further configured to communicate with the first communication device using the first set of functions, and communicate with the second communication device using the second set of functions.
